(19) United States
(12) Patent Application Publication
(10) Pub. No.: US 2017/0023359 A1
(43) Pub. Date: Jan. 26, 2017

(54) ULTRASONIC GEOMETRY TESTING, INVOLVING INACCURACY CORRECTION OF TRANSDUCER POSITIONING

(71) Applicant: GE SENSING & INSPECTION TECHNOLOGIES GmbH, Huertg (DE)

(72) Inventors: Reinhard PRAUSE, St. Augustin (DE); Robert PEIP, Huerth (DE); Norbert STEINHOFF, Erftstadt (DE)

(21) Appl. No.: 15/302,675

(22) PCT Filed: Apr. 2, 2015
(86) PCT No.: PCT/EP2015/057378

§ 371 Date: Oct. 7, 2016

(30) Foreign Application Priority Data
Apr. 14, 2014 (DE) 102014105308.7

(51) Int. Cl. G01B 17/00; G01N 29/30; G01N 29/07; G01N 29/26

(52) U.S. Cl. CPC G01B 17/00; G01N 29/262; G01N 29/30; G01N 29/07; G01N 2291/106; G01N 2291/2634

(57) ABSTRACT

The invention relates to a method for ultrasonic geometry testing of a test object (28) at various measuring positions distributed along a surface (26) of a test object (xₙ) by means of at least one ultrasonic transducer, comprising a plurality of steps. First, a calibration device (20) with known dimensions (OD_{cal}(xₙ)) is provided. Then there follow several calibrating steps, during each of which a measuring position specific distance (WP(xₙ)) between calibration device (20) and ultrasonic transducer (10) is determined and stored by an ultrasonic transit time method, by at least one echo on at least one surface of the calibration device (20), using the known dimension (OD_{cal}(xₙ)) for each measuring position ₙ. Subsequently, a test object (28) is provided, at which ultrasonic transit time measurements are performed in multiple test steps. Transit time measurements are thereby taken at several measuring positions xₙ, using at least one echo on at least one surface (26) of the test object (28). In the following evaluation step a dimension (27) of the test object is calculated using the measuring position-specific distances WP(xₙ).

The present invention relates to a method for determining an unknown dimension/geometry of a test object by means of ultrasonic testing, using the echo transit time method in particular, wherein a plurality of dimensions or geometries is determined while changing the sound radiation site/measuring position. When measuring geometries from different measuring positions, the accuracy of the measurement depends on the positioning accuracy of the respective ultrasound generating transducer. The accuracy of the arrangement of an ultrasonic transducer and/or the knowledge of exact distance between the ultrasonic transducer and a reference value is crucial for an accurate assessment of the geometry of a test object. The mechanical alignment, the positioning of individual ultrasonic transducers, as well as the manufacturing of ultrasonic probes and ultrasonic transducers arranged therein, are subject to limitations in terms of precision.

This problem arises in particular when the transducer is moved relative to the measurement object, but also when the sound radiation site is changed, for example, by selectively actuating single or multiple groups of transducers of a phased array. Especially with such phased arrays, two problems occur after their production: Firstly, a sufficiently precise arrangement in a shared location of all the transducers and/or their sound radiating surfaces cannot be guaranteed, and secondly, the shared location surface of the transducers is not strictly parallel to the test object surface to be ultrasonically tested.

Against this background, the present invention has the object to present a method for ultrasonic geometry testing, in which the geometry is measured with improved precision. This object is achieved by a method having the features of claim 1. Further advantages and features of the invention will become apparent from the sub-claims.

It should be noted that the features listed individually in the claims can be combined in any technically meaningful way with each other to show further embodiments of the invention. The description additionally characterizes and specifies the invention, especially in combination with the figures.

The invention relates to a method for ultrasonic geometry testing of a test object at several measuring positions distributed along a surface of a test object, by means of at least one ultrasonic transducer, involving the following steps:

In a first step of the method, known as calibration device deployment phase, a calibration device with at least one known dimension is provided.

In several subsequent steps of calibration, collectively known as calibrating phase, a measuring position specific distance between calibration device and ultrasonic transducer is determined with an ultrasonic transit time method, and by means of at least one echo on at least one surface of the calibration device, using the known dimension for each measuring position. The distance is stored, for example, in a non-volatile memory.

In a subsequent step, known as test object deployment phase, a test object with unknown dimension(s) is provided for measurement, taking into account the measuring positions.

In several subsequent steps, known as measuring steps, of the ultrasonic transit time measurement procedure, transit time measurements are carried out on the test object at the various measuring positions by means of at least one echo on at least one surface of the test object.

In at least one subsequent or intermediate evaluation step, a dimension of the test object is calculated, in particular for each measuring position, using the stored measuring position-specific distances.

The approach of the present invention allows assessment of the exact position of the sound radiation sites with the aid of a calibration device, to store this measurement specific information, and to use it when evaluating a sound radiation from the same sound radiation site. Thereby it becomes possible to obtain an accurate value for the dimension of the test object with respect to the measuring position. It is therefore clear to the skilled person that the aforementioned term “distance” is to be interpreted broadly and also comprises those dimensions and values which are clearly derived from the spatial distance defined by the calibration device, such as the measuring position-specific transit time and the like.

Preferably, at least one phased array consisting of several ultrasonic transducers is used for ultrasonic geometry testing, specifically during the calibration and test steps. Preferably, the ultrasonic transducers of the phased array are selectively actuated during the calibration and test steps, to define the different measuring positions, which are equally valid for both calibration and test steps. When using a phased array, the calibration device and the test object are preferably not moved relative to the phased array, nor translationally in only one direction.

Preferably, the ultrasonic transducers of the phased array are not arranged on a shared surface parallel to the surface of the calibration device. In an exemplary case, the surfaces of the calibration device and the test object to be measured have a curvature and the ultrasonic transducers are arranged on a surface that follows this curvature approximately, but is not exactly parallel. The approach of the invention makes a precise adjustment of the transducer arrangement to the surface profile of the test object dispensable.

According to one embodiment, at least the test object is rotationally symmetrical, but preferably both the test object and the calibration device. In an exemplary case, the object is a tube or a rod. In an exemplary case, the eccentricity of the rotationally symmetric test object or calibration device is determined.

According to a further embodiment, the dimension established in the evaluation step can be used to determine the position of the test object in the ultrasonic device, consisting essentially of one or more ultrasonic transducer and of the means for positioning and, where applicable, of transporting ultrasonic transducer and test object or calibration device.

According to a preferred embodiment of the method, an outer diameter of the test object, e.g. the maximum outer diameter, is determined during the evaluation step.

According to a preferred embodiment, the measuring position specific distance is the clear distance from the ultrasound transducer to the nearest outer surface of the calibration device.

According to another embodiment, a rotating relative movement between the ultrasonic transducer and the calibration device and test object occurs intermediately or concurrently with the test and calibrating steps. The method of the invention thereby compensates the problem of positioning inaccuracy during relative rotation.

Preferably, coupling between the ultrasonic transducer and the surface of the test object is carried out by a rotating water jacket. Such a procedure and a test apparatus are disclosed in EP1332359 A1, the disclosure of which is hereby incorporated into the context.

According to a preferred embodiment of the method, the measuring positions are arranged on a circumference around the calibration device and the test object, and preferably in uniform distribution over the circumference.

Preferably, two distances from a pair of ultrasonic transducers, which in an exemplary case are diametrically facing each other, are measured in each calibrating step and in each test step per measuring position.

Other features and advantages of the invention will become apparent from the following non-limiting description of a system design example, which further illustrates the method of the invention with reference to the relevant figures. The following schematic representations are provided:

Parts identical in function are always given the same reference number across the various figures. Therefore they are usually described only once.

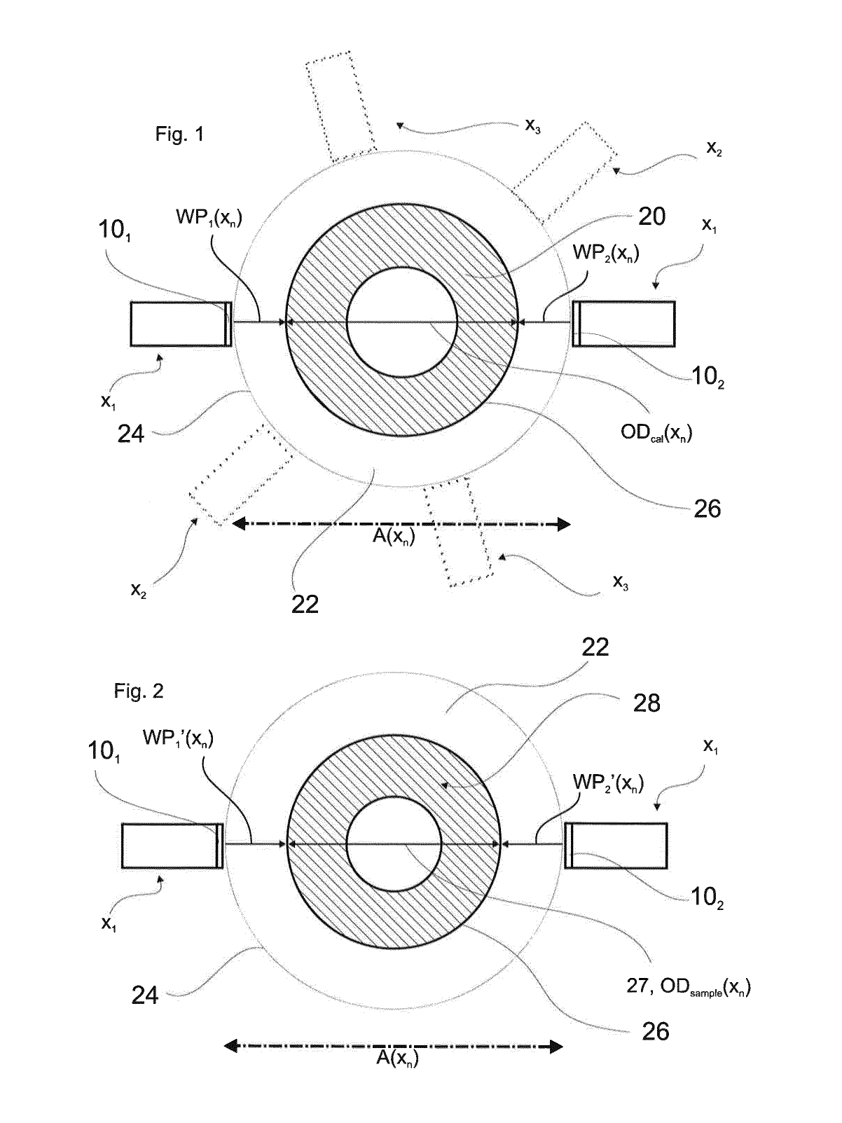

FIG. 1: a representation of the variables measured and determined in a calibrating step,

FIG. 2: a representation of the variables measured and determined in a calibrating step with a phased array.

Parts identical in function are always given the same reference number across the various figures. Therefore they are usually described only once.

FIG. 1 shows an arrangement of two ultrasonic transducers 10₁, 10₂, and a rotationally symmetrical calibration device 20, which are designed to carry out the calibrating steps according to a first design example of the method. The coupling between the ultrasonic transducers 10₁, 10₂ and the calibration device 20 is carried out by a rotating water jacket 22.

The method is designed to perform the calibrating steps at several different measuring positions xₙ, located on a circumference 24 around the calibration device 20. The index “n” is used for numbering the different measuring positions xₙ and can take values between 1, 2, 3, . . . n. In an exemplary case, three measuring positions x₁, x₂ and x₃ are defined on a circumference 24 around the calibration device 20. The two ultrasonic transducers 10₁, 10₂, the indexes each relate to a first and a second ultrasonic transducer 10₁, 10₂, which are used in a step of the process, are diametrically facing each other and are located on their measuring position x₁.

For the measuring position x₁ in each case a distance WP₁ (x₁) and WP₂(x₁) of the first and second ultrasonic transducer 10₁, 10₂ to a surface 26 is determined and stored, in this case to an outer surface of the calibration device 20. In the first design example shown, the calibration device 20 is a tube with an outer diameter OD_{cal}(xₙ) known and identical for each measuring position xₙ (outer diameter calibration).

By means of the outer diameter OD_{cal}(xₙ) it is possible to calculate and store the stretch of movement Axₙ between the ultrasonic transducers for each measuring position xₙ. The measuring position follows from the known outer diameter OD_{cal}(xₙ), and the two distances WP1(xₙ) and WP2(xₙ), with Axₙ=OD_{cal}(xₙ)+(WP1(xₙ)+WP2(xₙ)).

As the stretch of movement Ax between the ultrasonic transducers 10₁, 10₂ does not change from the calibrating steps to the test steps, a dimension 27 of a test object 28 can be calculated during the test steps by identifying the measuring position specific distances WP₁′(xₙ) and WP₂′(xₙ).

FIG. 2 illustrates which variables are determined to calculate dimension 27 of the test object 28. In the example shown, the arrangement corresponds to the one known from FIG. 1, whereby the test object 28 is positioned at the location of the calibration device 20. Test object 28 is a tube with an unknown outside diameter ODₛₐₘₚₗₑ(xₙ), whereby, specific to the measuring position, dimension 27 of the unknown diameter ODₛₐₘₚₗₑ(xₙ) of the test object is determined.

In the course of test steps, by transit time measurements on a surface 26, in this case the outer surface of the test object 28, the measuring position specific distances WP1′(xₙ) and WP₂′(xₙ) of the ultrasonic transducers 10₁, 10₂ are determined. The measurements are carried out at the measuring positions xₙ, which correspond to the measuring positions x₁, of the calibrating steps. Since the stretch of movement Ax between the ultrasonic transducers 10₁, 10₂ has not changed and the distances WP₁(xₙ) and WP₂(xₙ) are stored, an outer diameter ODₛₐₘₚₗₑ(xₙ) of the test object at the measuring position xₙ can be determined, with ODₛₐₘₚₗₑ(xₙ)=OD_{cal}(xₙ)+(WP1(xₙ)+WP2(xₙ))−(WP1′(xₙ)+WP₂′(xₙ)).

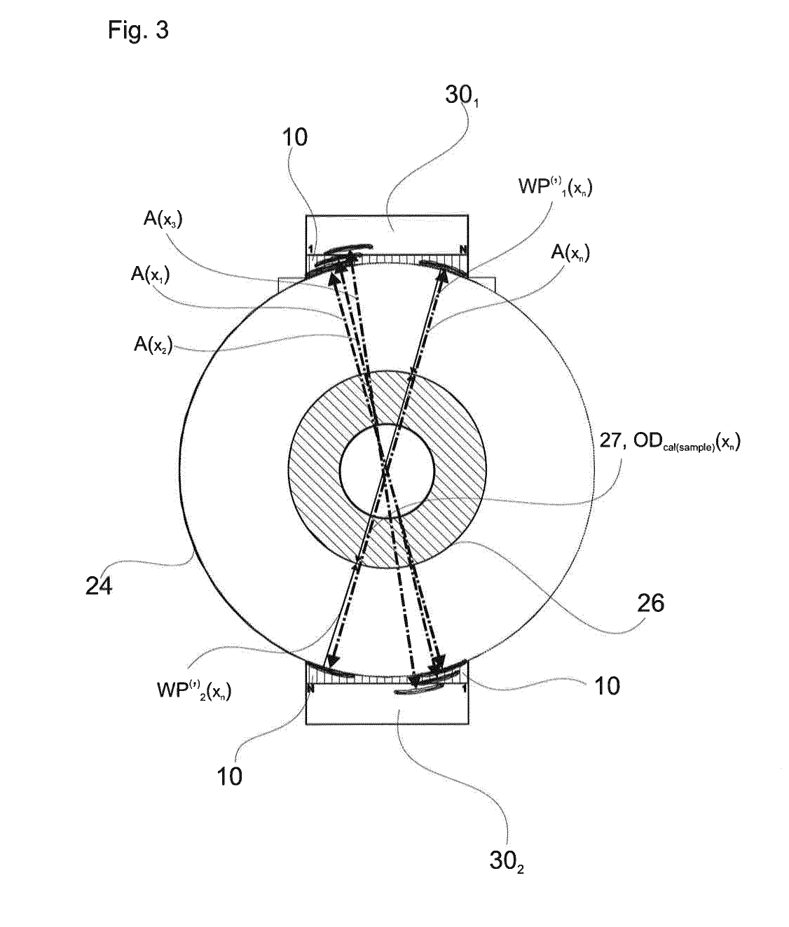

FIG. 3 shows an alternative embodiment of an arrangement of ultrasonic transducers 10 and a calibration device 20, or a test object 28. The arrangement is analogous to the one described under FIG. 1 and FIG. 2, and also the steps of the method are analogous to the steps described above. However, in the design example shown, instead of two ultrasound transducers 10₁, 10₂ two phased arrays 30₁, 30₂ are arranged on a circumference 24 around the calibration device 20 or the test object 28. The first and second phased array 30₁, 30₂, which are used during a calibrating or test step, are diametrically facing each other and each include a number 1, . . . , N of selectively controllable ultrasonic transducers. By selectively actuating individual ultrasonic transducers 10 or a group of ultrasonic transducers 10, different measuring positions xₙ can be defined. In the design example shown, the surface of the calibration device 28 and of the test object 28 to be measured has a curvature and the ultrasonic transducers 10 are arranged on a surface which follows this curvature and is approximately parallel. The approach of the invention makes a precise adjustment of the ultrasound transducer arrangement to the surface of the calibration device 20 or the test object 28 dispensable.

1. A method for ultrasonic geometry testing of a test object (28) at a plurality of different measuring positions (xₙ) distributed along a surface (26) of a test object (28), by means of at least one ultrasonic transducer (10), involving the following steps:
a step of providing a calibration device 20 with known dimension (OD_{cal}(xₙ));
several subsequent calibrating steps, during each of which a measuring position specific distance (WPᵢ(xₙ)) between calibration device (20) and ultrasonic transducer (10) is determined and recorded by an ultrasonic transit time method, by means of at least one echo on at least one surface (26) of the calibration device (20), using the known dimension ((OD_{cal}(xₙ)) for each measuring position; (xₙ); subsequently
a step of providing a test object (28);
several test steps in the ultrasonic transit time measurement on the test object (28), wherein at the plurality of measuring positions (xₙ) transit time measurements are taken by means of at least one echo on at least one surface (26) of the test object;
at least one evaluation step, wherein, using the measuring position specific distances (WPᵢ(xₙ) a dimension (27, ODₛₐₘₚₗₑ(xₙ) of test object (28) is calculated, in particular for each measuring position (xₙ) one dimension (27, ODₛₐₘₚₗₑ(xₙ).

2. Method according to claim 1, wherein at least one phased array (30) consisting of several ultrasonic transducers (10) is used for the calibrating steps and the test steps.

3. Method according to the preceding claim, wherein the ultrasound transducers (10) of the phased array (30) are selectively actuated and define different measuring positions (xₙ).

4. Method according to one of the two preceding claims, wherein the ultrasonic transducers (10) of the phased array (30) are not arranged on a shared surface parallel to the surface (26) of the calibration device (20) or of the test object (28).

5. Method according to one of the preceding claims, wherein the test object (28) is rotationally symmetrical.

6. Method according to any one of the preceding claims, wherein an outer diameter (ODₛₐₘₚₗₑ(xₙ) of the test object (28) is determined during the evaluation step.

7. Method according to any one of the preceding claims, wherein the measuring position specific distance is the clear distance of the ultrasonic transducer (10) to the nearest outer surface of the calibration device (20).

8. Method according to any one of the preceding claims, wherein intermediately or simultaneously with the testing and calibrating steps, a rotating relative movement is carried out between the ultrasonic transducer (10) and calibration device (20) and test object (28).

9. Method according to one of the preceding claims, wherein the coupling between the ultrasonic transducer (10) and the surface (26) of the test object (28) is carried out by a rotating water jacket (22).

10. Method according to one of the preceding claims, wherein the measuring positions (xₙ) are designed so that they are situated on a circumference (24) around the calibration device (20) and the test object (28).

11. Method according to any one of the preceding claims, wherein, in each calibrating step, and in each test step for each measuring position (xₙ) two distances (WP1(xₙ), WP2(xₙ), WP1′(xₙ), WP₂′(xₙ)) of a pair of transducers, which are, in an exemplary case, diametrically facing each other, are measured or determined.
